(19) United States
(12) Patent Application Publication
(10) Pub. No.: US 2004/0159975 A1
(43) Pub. Date: Aug. 19, 2004

(54) Method of forming a decorative structure and a decorative structure made by the method

(76) Inventors: Trevor David Cox, Gillingham (GB); Stephen James Elliot, Gillingham (GB)

Correspondence Address: BAKER & BOTTS, 30 ROCKEFELLER PLAZA, NEW YORK, NY, 10112

(21) Appl. No.: 10/773,663

(22) Filed: Feb. 6, 2004

(30) Foreign Application Priority Data
Feb. 7, 2003 (GB) GB 0302755.4

(51) Int. Cl. B29C 39/10; B29C 33/60; B29C 71/02

(52) U.S. Cl. 264/236; 264/259; 264/338

(57) ABSTRACT

A method is provided for forming a decorative structure, for example a decorative glass sheet for a window panel. The method includes positioning a mould, having a contoured surface formed of a substantially inelastic material, against a sheet to form a mould cavity between the sheet and the mould; introducing a curable resin into the mould cavity; curing the resin to form a resin layer having a decorative surface which corresponds to the contoured surface of the mould; and releasing the mould to leave a laminate which comprises the resin layer adhered to the sheet.

### CROSS-REFERENCE TO RELATED APPLICATIONS

This application claims priority from U.K. Application No. GB 0302755.4, which was filed on Feb. 7, 2003.

### FIELD OF THE INVENTION

The present invention relates to a method of forming a decorative structure and a decorative structure made by the method. It is more particularly, but not exclusively, concerned with a method of forming decorative structures such as windows, panels and mirrors that have the appearance of textured glass or deeply contoured glass.

### BACKGROUND TO THE INVENTION

In order to obtain brilliant cut or beveled glass a process is used in which CNC (computerized numerical control) machines use diamond tipped heads cooled with water to cut grooves and curved shapes into a glass surface. This process requires expensive equipment and is difficult and expensive to carry out for complex patterns and for a large number of panels.

U.S. Pat. No. 5,783,264 (Howes) is concerned with the production of windows having the appearance of textured and deeply contoured glass, and contains a review of attempts to make such articles up to the beginning of the 1990's. In particular it identifies one method of making such articles that involves forming a mould over the surface of an original article using silicone. Then, the formed mould is filled with a resin, which is allowed to cure within the mould before it is removed as a replica. Traditional mould release agents, such as Teflon or silicone, have been sprayed on solid surfaces, to prevent adhesion between the mould material and the cured resin replica articles.

However, the removal of a silicone mould from a glass master posed particular problems. The adhesive forces between the silicone and the glass were so great that using conventional prior art mould release agents as few as one in twenty moulds were successfully removed from the masters without serious damage. Furthermore, the use of traditional mould release agents, applied to the master before pouring the mould, rendered the mould unacceptable for producing replicas of adequate quality since the agents left impressions in the mould that were subsequently transferred to the replicas as roughened surfaces. Due to the intended use of replicas to transmit light and to produce aesthetic effects similar to those produced by cut and polished glass surfaces, the production of plastic decorative glass replicas is much more sensitive to blemishes than is the production of virtually all other plastic parts by molding processes.

One disclosed solution to the prior art problems of using the decorative glass replica in architectural applications, such as doors and windows, was forming the plastic decorative layer on a conventional glass pane, which then acted as a backing for the decorative plastic layer. A technical problem still requiring resolution was the adhesion between the cured resin plastic layer and the glass pane used as the backing plate. The disclosed solution involves production of a decorative window in which a thick transparent resin layer is laminated to a sheet of glass. The resin layer can be decorative and can have a finely textured surface. Howes goes on to describe a method of forming such a structure by forming a silicone mould made from a master using a silicone elastomer, placing the mould over a sheet of glass which has been coated with an adherent layer, filling the mould with resin, allowing the resin to set and removing the mould. The adherent layer disclosed is formed of an organosilane and the resin disclosed is a polyester resin which is mixed with an organosilane ester and a small amount of a peroxide catalyst so that after the mould has been filled with resin the resin hardens to form a structure and the mould can then be removed.

However, the presence of the organosilane ester, and in particular the use of a mould of silicone elastomer (rubber) adversely affects curing of the surface of the polyester resin leaving it sticky to the touch. This means that extreme care needs to be taken once the silicone mould has been removed since the sticky surface of the molded-on resin layer is easily contaminated with dust, debris and finger marks, which cannot be removed without showing evidence. In addition the use of silicone rubber moulds requires direct heating of the resin to bring about an effective cure. The resin can react with the mould to bring about styrenisation of the mould so that that after a number of castings the mould has to be thoroughly cleaned, washed and dried. Silicone rubber moulds eventually lose their flexibility and hairline cracks appear which render the mould useless.

### SUMMARY OF THE INVENTION

In one aspect the invention provides a method of forming a decorative structure, which method comprises:

(a) positioning a mould, having a contoured surface formed of a substantially inelastic material, against a sheet to form a mould cavity between the sheet and the mould;

(b) introducing a curable resin into the mould cavity;

(c) curing the resin to form a resin layer having a decorative surface which corresponds to the contoured surface of said mould; and

(d) releasing the mould to leave a laminate which comprises said resin layer adhered to said sheet.

### DESCRIPTION OF PREFERRED FEATURES

An original for providing a molding pattern may be a sheet of glass e.g. formed with a decorative beveled and/or engraved pattern and having regions formed with decorative surface texture. Alternatively these features may be formed in a sheet of readily formed material e.g. acrylate or other plastics sheet.

For creation of a mould from the original, it is treated with a release agent, after which a mould of the type described below is built up layer by layer, allowed to cure and then removed.

The mould surface may be comprised of any substantially inelastic material, and preferably the mould is made of a substantially inelastic material. The mould used may be based on glass or other fiber reinforced plastics of sufficient rigidity e.g. 1-5 mm to be self-supporting. It may have a top or gel coating of polyester, vinyl ester, epoxy or metal, with vinyl ester being preferred. Advantageously comprises at least one area for pattern creation bounded by one or more grooves for receiving sealing strip of elastomeric material. Silicone elastomers have been found to be suitable for the sealing strip, and Shore-A hardness of about 40-80, preferably 60-80 may be appropriate. The sealing strip may be of height about 10 mm and of width about 5 mm, and it should preferably be compressible under the intended molding conditions to bring about approximately a 10% reduction in its height to effect sealing of the mould cavity and to provide energy to effect release of a cured glass-resin laminate from the mould. The sealing strip or strips locate in the groove or grooves in the mould and the height of the strip projecting above the surface of the mould controls the thickness of the resin layer produced on the eventual glass surface. Preferably there is a release agent such as gel, oil or wax, or chemical release agent on the surface of the mould so that the mould is readily releaseable from cured resin. The substantially inelastic material forming the mould surface may be reinforced by a material to form a rigid structure. If required the surface of the mould may be patterned so that surface effects can be formed on the casting. Furthermore, the mould may be divided into separate sections and different casting resins may be introduced in different section e.g. so that different sections can have different colors.

The sheet may be clear or it may be colored or decorated as required. If the sheet is silvered, aluminized or otherwise metallized, a mirror can be formed. The sheet is preferably of glass, but it may also be a rigid resin or plastics sheet or the like.

A glass sheet is preferably coated with a layer to improve bonding of the resin to the glass. A suitable layer is silane or mixture of silanes in solution e.g. in water or an alcohol. Advantageously the or at least one of the silanes both has a group that is reactive with the surface of the glass sheet and a group having ethylenic unsaturation for copolymerization into the transparent casting material used in the subsequent molding step, e.g. an α,β-unsaturated ester structure connected to silicon by an at least C₂ chain as in γ-methacryloxypropyltrimethoxysilane. Additional or alternative adhesion promoters may be based on e.g. on vinyltrimethoxysilane and other organosilanes containing vinyl, α,β-unsaturated keto or α,β-unsaturated ester groups differing in chain length.

To form the structure of the invention the mould is preferably positioned so that it is at an angle to the horizontal and the glass sheet is clamped to the mould to form a mould cavity. There is an inlet at the lower end of the mould where casting resin can be introduced and an air outlet at the top of the mould. Casting resin together with hardener is introduced into the mould at its lowest point and progressively fills the mould. Displaced air goes out through the air outlet. This procedure reduces the possibility of air bubbles being formed.

The casting resin is preferably a resin which, when it cures, forms a hard transparent glass-like surface on the sheet, such as a polyester e.g. an acrylate or polyacrylate which is introduced into the mould cavity with a hardener so that it cures to form a hard resin. As the mould is not made of silicone elastomer, surface cure of at least the major or image-bearing face of the casting resin is not impaired, and cure of the casting resin can progress substantially to completion without the necessity for direct heating. The surface of the resulting cast resin structure is fully cured and is hard and dry to the touch. This allows sheets decorated with the casting resin to be used in a single-glazed environment e.g. to produce mirrors, door panels, kitchen doors and shower screens. The casting resin can be encapsulated within an insulated glass unit e.g. a double glazing unit formed from first and second glass layers permanently fastened and sealed together or applied to the surface of such a unit.

In the case of a glass sheet, very desirably the casting resin has substantially the same refractive index as the sheet. The resin then picks up the color of the glass so that the bevels formed in the resin coating layer really look as if they were made of glass. The refractive index of window glass (crown glass) is typically 1.51-1.55 whereas that of polymethyl methacrylate is about 1.49. Matching of refractive index can be achieved by using a copolymer of a vinyl aromatic compound which has a refractive index of e.g. 1.58-1.6 when polymerized and a copolymerizable vinyl monomer as disclosed, for example, in U.S. Pat. Nos. 3,968,073 (Hara; Mitsui Toatsu Chemicals) and 4,344,906 (Kitagawa, Sumitomo Chemical Company).

As vinyl aromatic monomers there may be mentioned styrene, vinyltoluene, α-methylstyrene, α-methyl-p-methylstyrene, α-methyl-m-methylstyrene, vinylxylene, α-methylvinylxylene, α-chlorostyrene, p-chlorostyrene, m-chlorostyrene, α-methyl-p-chlorostyrene, α-methyl-m-chlorostyrene and α-chlorovinylxylene, which may be used individually or as mixtures of two or more of the above compounds. For the industrial purpose, styrene is most preferred, followed by vinyltoluene and α-methylstyrene.

As polymerizable vinyl monomer there may be mentioned methyl methacrylate which is preferred and additionally acrylic acid, methacrylic acid, methyl acrylate, ethyl acrylate, ethyl methacrylate, isopropyl acrylate, isopropyl methacrylate, n-propyl acrylate, n-propyl methacrylate, isobutyl acrylate, isobutyl methacrylate, tert-butyl acrylate, tert-butyl methacrylate, n-butyl acrylate, n-butyl methacrylate, cyclohexyl acrylate, cyclohexyl methacrylate, β-hydroxyethyl acrylate, β-hydroxyethyl methacrylate, β-hydroxypropyl acrylate, β-hydroxypropyl methacrylate, glycidyl acrylate, glycidyl methacrylate, 2-cyanoethyl acrylate, 2-cyanoethyl methacrylate, β-ethoxyethyl acrylate, β-ethoxyethyl methacrylate, 2-ethylhexyl acrylate, 2-ethylhexyl methacrylate, acrylonitrile, methacrylonitrile, N,N-dimethylaminoethyl methacrylate, acrylamide, methacrylamide, diacetone acrylamide, vinyl acetate and vinyl chloride, which may be used alone, in admixture and as co-monomers with methyl methacrylate.

A typical casting mixture of type known for making transparent glass-fiber impregnated sheets could, for example comprise 30 parts by weight of a copolymer of styrene (26 wt %) and methyl methacrylate (74 wt %) dissolved in 70 parts by weight of a monomer mixture comprising styrene (21.7 wt %), methyl methacrylate (74 wt %), ethylene glycol dimethacrylate (1.43 wt %) and maleic anhydride (2.86 wt %) which immediately before casting is mixed with an initiator such as benzoyl peroxide. Casting mixtures based on methyl methacrylate and styrene or other aromatic monomer advantageously incorporate a flexible polyester which not only gives rise to a scratch resistant and mar-resistant slip surface but also imparts flexibility and reduces shrinkage on molding. Some molding resins in addition to being too brittle exhibit about 6-7% shrinkage on curing which creates undue stress when they are applied as coatings to workpieces which may typically be 1 meter in length. In extreme cases the forces created on curing the coating material may be sufficient to bring about objectionable mechanical deformation of a previously flat sheet. Preferably the molding resin is formulated to have linear shrinkage of 5% or less and most preferably 2% or less while being strongly adherent to the glass sheet either intrinsically or using a bonding agent as described above. Crystalite resin described below has an appropriate combination of properties and is preferred for use in the invention.

A preferred molding method which avoids development of unwanted air bubbles involves the step of positioning the mould so that the mould cavity is inclined to the horizontal,

introducing said curable resin in a position proximate the lowest point of said mould cavity, and

venting air displaced by said curable resin from said mould cavity at a position proximate the uppermost point of said mould cavity.

### BRIEF DESCRIPTION OF THE DRAWINGS

How the invention may be put into effect will now be described with reference to the following drawings, in which:

FIG. 1 shows a schematic view of a mould;

FIG. 2 shows a side view of the mould partially filled with resin;

FIG. 3 shows a side view of the mould full of resin;

FIG. 4 is a diagrammatic sectional view of a mould, glass panel and one of a plurality of clamps according to a second embodiment of the invention; and

FIG. 5 is a plan view of a mould looking at a gel-coated molding face thereof.

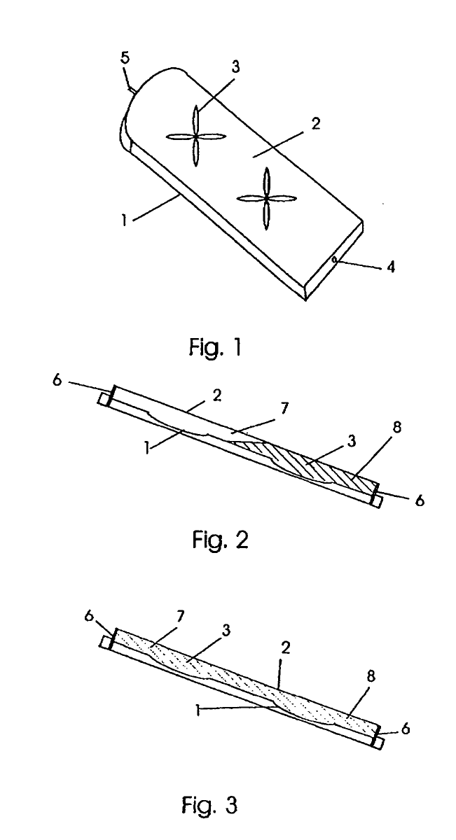

### DESCRIPTION OF PREFERRED EMBODIMENTS

The invention will now be further described in the following examples.

### EXAMPLE 1

A substantially inelastic mould 1 is coated with a release agent and has silicone rubber strips 6 located in grooves in the mould to define an area of the mould. Transparent glass sheet 2 is placed on the silicon rubber strips and clamped in p-lace to define a mould cavity 7 between the mould 1 and the glass sheet 2. An acrylate resin and hardener 8 is introduced into the mould at the inlet 4 to fill the mould cavity 7 and the displaced air exits at outlet 5. After about 60 minutes at ambient temperature the resin cures to form a hard transparent resin adhered to the glass sheet 2, and the mould is unclamped and separated from the glass sheet. The glass sheet with a contoured surface can then be used e.g. as window or door panel and the like.

### EXAMPLE 2

An original of a decorative design to be applied as a layer to a sheet is formed by cutting an acrylic sheet, for example using a router under computerized numerical control (CNC). Areas of the original that are textured but otherwise plain are created by applying to the acrylic sheet thin adhesive film having one face formed with the desired texture and having an adhesive coating on the opposite face.

The completed original is then used to create a mould. For this purpose, the original is coated with a release agent, after which the original is coated with a top or so-called gel coat layer which is of a curable vinyl ester resin. The gel-coat layer then has applied thereto layers of resin and glass cloth in sufficient thickness e.g. about 2-3 mm to form a rigid self-supporting mould. The resin is allowed to cure and the finished mould is separated from the original.

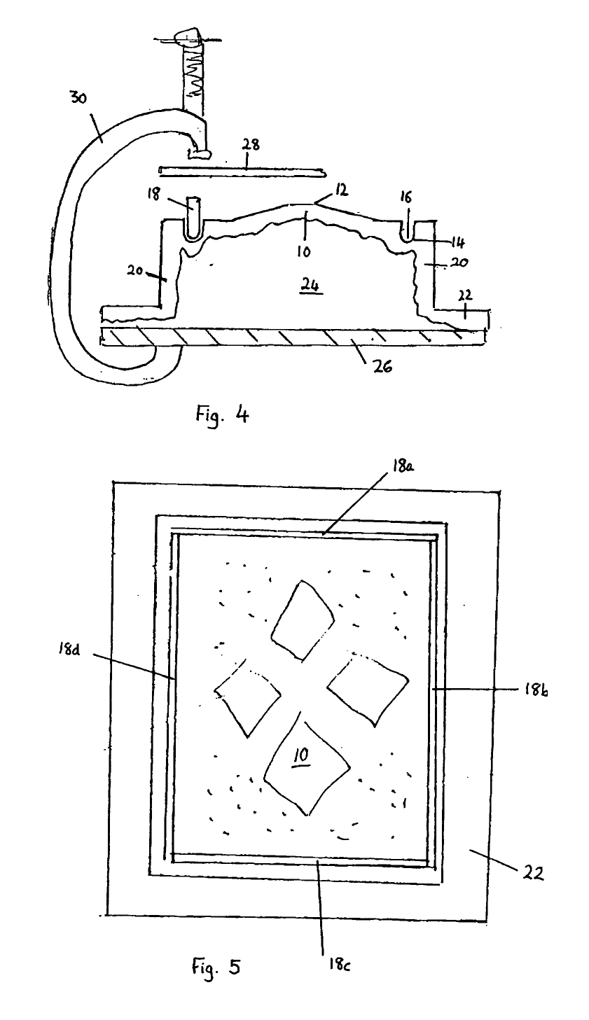

The structure of the mould which is produced in the above process is shown in FIG. 4. It has a central image-bearing region 10 whose gel-coated outer surface 12 carries a negative impression of the pattern to be reproduced. The region 10 is bounded by a peripheral region 14 which presents to the molding surface 12 a peripheral grooves 16 for receiving adjustable sealing strip 18 which is a silicone rubber extrusion of Shore A hardness about 60-80, depth about 10 mm and width about 5 mm. The grooves 16 are arranged so that when one or more sealing strips are inserted therein, the strip or strips surround the image-bearing region 10 without discontinuity that would allow escape of resin during the molding step to be described below. For a rectangular panel as shown in FIG. 5 there will be four such strips 18a-18d whose ends are in contact and under slight compression to effect a seal against escape of molding resin. Reverse flanges 20 bound the central region 10 and extend generally at right angles away from the uncoated face thereof, and they terminate in out-turned flanges 22. A void 24 defined by the central region 10 and by the flanges 20 is filled with a polyester-based filler, after which a support sheet 26 of plywood or other suitable material is offered up to close the void 24 and adhere to the out-turned flanges 22 as shown.

The completed mould can then be used to create decorative structures on sheets of glass or other material. For this purpose the working face 12 of the mould is coated with a release agent, e.g. a silicone- or fluorocarbon-based release agent, and the sealing strips 18 are introduced into the grooves 16. A glass sheet 28 is treated with one or more silane-based adhesion promoters (e.g. γ-methacryloxy-propyltrimethoxysilane, Silquest A-174, OSi Specialities, Inc) in iso-propanol and then contacted with the sealing strips 18, after which the assembly is secured together e.g. by clamps so as to compress the sealing strips 18 longitudinally by about 1 mm. The resulting mould cavity is then filled with a clear casting resin as described in the previous example to avoid the development of air bubbles, and allowed to cure. A preferred clear casting resin is available from Creative Resins International of Sittingbourne, Kent, UK under the trade name Crystalite The resin is conveniently injected into the mould cavity using a Crystalite injection machine available from the same suppliers. That machine is a pneumatically powered and provides accurate mixing and injection of resin systems at an output rate from 150 g/min to 4 kg/min. Its facilities include catalyst ratio adjustable from 0.5% to 3.0%, solvent/air flush, resin recirculation at the mix-head and a mould pressure guard that can protect the mould from excessive injection pressure, and to optimize mould fill performance. On cure of the casting resin which typically takes place in about 60 minutes, the clamps are released and recovery of the sealing strips urges the assembly of the glass panel and the cured casting resin away from the mould.

The mould is then ready for re-use and it has been found that in favorable conditions up to 20-30 decorative structure creation runs can be carried out before the mould has to be re-coated with release agent.

The procedure described in this example can be used to create resin bevels (decorated sheets) several times faster than using conventional silicone rubber moulds. The finished panels exhibit a dry surface so that they are less vulnerable to contamination by fingerprints or dust. They can be stored in an upright position as soon as they have been produced and can easily be incorporated into sealed units because there are no special handling issues. They can also be used as door or infill panels and the like because their exposed surfaces are both dry to the touch which differs from the toffee-like consistency of bevels made using prior silicone moulds which calls for immediate isolation from sources of dust and contamination. The resin bevels are substantially free from air bubbles in the resin layer. Furthermore, styrene emission during the manufacturing process is reduced to a degree such that the mould can be regarded as a closed system, and expensive extraction and filtering systems for removal of styrene released into the atmosphere may be unnecessary.

1. A method of forming a decorative structure, comprising:
(a) positioning a mould against a sheet to form a mould cavity between the sheet and the mould wherein the mould comprises a contoured surface formed of a substantially inelastic material;
(b) introducing a curable resin into the mould cavity;
(c) curing the curable resin to form a resin layer comprising a decorative surface corresponding to the contoured surface of the mould; and
(d) releasing the mould to leave a laminate wherein the laminate comprises the resin layer adhered to the sheet.

2. A method as claimed in claim 1, wherein the mould is formed of substantially inelastic materials.

3. The method of claim 1, wherein the mould has a working surface of a polymerized vinyl ester.

4. The method of claim 1, wherein the mould comprises a groove and wherein the groove further comprises an adjustable sealing strip and wherein the sheet is positioned on the adjustable sealing strip wherein the height of the adjustable sealing strip above the mould controls the thickness of the resin layer.

5. The method of claim 4, wherein the sealing strip comprises an elastomer.

6. The method of claim 1, wherein the contoured surface of the mould is reinforced.

7. The method of claim 1, wherein the sheet is a transparent glass sheet.

8. The method of claim 1, wherein the sheet is a translucent glass sheet.

9. The method of claim 1, wherein the curable resin is a polyester resin wherein when the polyester resin cures it is substantially transparent.

10. The method of claim 9, wherein the curable resin comprises a hardener so that it cures to form a hard resin.

11. The method of claim 1, wherein the resin comprises units derived from an acrylic monomer and units derived from a vinyl aromatic monomer wherein the refractive index of the resin after curing matches that of the glass.

12. The method of claim 1, wherein the resin comprises methyl methacrylate and styrene.

13. The method of claim 12, wherein the resin further comprises a polyester for imparting flexibility.

14. The method of claim 1, wherein the curable resin exhibits shrinkage on curing of about 2%.

15. The method of claim 1, further comprising applying a release agent selected from the group consisting of oil, wax and chemical release agent to the surface of the mould prior to step (a).

16. The method of claim 15, further comprising the step of priming the surface of the glass with an adhesion promoter before the mould is positioned against the sheet.

17. The method of claim 1, further comprising positioning the mould so that the mould cavity is inclined to the horizontal,
introducing said curable resin in a position proximate to the lowest point of the mould cavity, and
venting air displaced by said curable resin from said mould cavity at a position proximate the uppermost point of said mould cavity.

18. A decorative structure made by the method of claim 1.
